(19) United States
(12) Patent Application Publication
(10) Pub. No.: US 2014/0240880 A1
(43) Pub. Date: Aug. 28, 2014

(54) COORDINATED CONTROL METHOD FOR POWER DISTRIBUTION SYSTEM WITH DC BUS ELECTRIFICATION SCHEME AND APPARATUS THEREOF

(71) Applicants: Yao Chen, Beijing (CN); Guoju Zhang, Beijing (CN); Jiuping Pan, Raleigh, NC (US); Lars Gertmar, Vasteras (SE); Rongrong Yu, Beijing (CN); Erich Suter, Beijing (CN)

(72) Inventors: Yao Chen, Beijing (CN); Guoju Zhang, Beijing (CN); Jiuping Pan, Raleigh, NC (US); Lars Gertmar, Vasteras (SE); Rongrong Yu, Beijing (CN); Erich Suter, Beijing (CN)

(73) Assignee: ABB TECHNOLOGY LTD.

(21) Appl. No.: 14/354,670

(22) PCT Filed: Apr. 16, 2012
(86) PCT No.: PCT/CN2012/074133

§ 371 Date: Apr. 28, 2014

(30) Foreign Application Priority Data
Apr. 16, 2012 (CN) PCTCN2012/074133

(51) Int. Cl. H02H 7/22

(52) U.S. Cl. CPC H02H 7/22
USPC 361/62

(57) ABSTRACT

The present invention discloses a coordinated control method for power distribution system with DC bus electrification scheme and apparatus thereof. The method comprises: detecting what kind of disturbances occurs, and at least one of following steps: restoring the voltages of the failed DC buses if power loss is detected on the DC buses due to temporary or permanent failures of upstream power supplies; controlling the voltage of the abnormal DC buses if overvoltage or under-voltage is detected on the DC buses due to internal or external disturbances; and supporting the voltages of the abnormal AC buses if overvoltage or under-voltage is detected on the AC buses due to internal or external disturbances. The methods and apparatus can further improve the fault-ride-through capability for power plant under external or internal disturbances, and facilitate smooth automatic switching process between two DC buses etc.

### FIELD OF THE INVENTION

The invention relates to the power distribution system with DC bus electrification scheme, and more particularly to coordinated control methods for power distribution system with DC bus electrification scheme and apparatus thereof.

### BACKGROUND OF THE INVENTION

A DC bus electrification scheme in power plant auxiliary system had been proposed in US2009/045795A1, titled as Improved Internal Electrification Scheme for Power Generation Plants. Compared with traditional AC bus systems, the DC bus system includes the following merits: reduced power loss, reduced reactive power consumption and improved energy efficiency, etc.

FIGS. 1 and 2 illustrate two DC bus-based Electrical Balance of Plant (EBoP) configurations with one generator and two generators respectively. According to the standard design in prior art, the auxiliary loads are configured for each generator with required capacity. Most of the auxiliary loads are electric motors which are used to drive pumps or fans. Typically, for the DC bus-based EBoP, the electric motors are connected to two DC buses (e.g. DC Bus 1 and Bus 2). It is optional to have an ESS (Energy Storage System) in each DC bus. As shown in FIG. 1 or 2, a normal-open circuit breaker (e.g. CB3) is installed between the two DC buses. In the case of loss of power supply to the DC Bus 1, the loads of this bus will be switched automatically to DC Bus 2 by turning on the CB3 to maintain the continuous operation of the auxiliary system.

For the DC bus-based EBoP system, the input power (provided by the rectifier) and the output power (consumed by the auxiliary loads) of the DC bus are balanced in a normal operation, so that a constant DC bus voltage can be maintained. When external disturbances occur, e.g. a short-circuit fault, the AC voltage of the auxiliary transformer will be decreased. Limited by the rated current of the rectifier, the input power to the DC bus will be decreased, which will result in DC bus voltage drop if the loads are kept unchanged. To solve this problem, the auxiliary loads should be controlled in such a way to balance the power and support the DC bus voltage.

Secondly, after generator load shedding, an overshoot of AC voltage of the auxiliary transformer will occur due to the transmission line fault clearance. By using the reactive power controllability of the rectifier, the voltage of the secondary winding of the auxiliary transformer can be maintained within certain range so as to keep normal operation of other auxiliary equipments. However, the capacity of the rectifier for reactive power support is limited, since the rectifier is usually sized only to supply the active power. To solve this problem, the auxiliary loads connected to the DC bus should be controlled in such a way to release the capacity of the rectifier temporarily to suppress the AC side voltage overshoot.

Thirdly, as shown in FIG. 1 or 2, each DC bus supplies part of the auxiliary loads. During normal operation these two buses are not connected. If any disturbance occurs at the power supply path of DC Bus 1, the normal-open circuit breaker between these two buses will be automatically closed to connect the loads of DC Bus 1 to Bus 2, to keep the operation of the auxiliary loads whilst to keep the continuous operation of the generator. However, the energy stored in the capacitors of DC Bus 1 usually is insufficient to maintain the DC voltage as before. The more voltage difference between the two DC buses, the larger inrush current will appear during the closure of the circuit breaker; which may cause some equipments or even the whole system damaged. To solve this problem, the rectifiers and the auxiliary loads should be controlled in such a way to reduce the voltage difference between the two buses so as to facilitate the automatic switching process.

Consequently, existing solutions including above mentioned prior art cannot be essentially used as the solution to further improve the fault-ride-through capability for power plant under external or internal disturbances. Due to the above mentioned problems, the present invention is to propose coordinated control methods for power distribution system with DC bus electrification scheme and apparatus thereof.

### SUMMARY OF THE INVENTION

The objects of the present invention are to control the active and reactive power flow for to an aspect of the present invention, it provides a coordinated control method DC bus voltage control and AC system voltage support under internal or external disturbances. Hence, the present invention provides coordinated control methods for power distribution system with DC bus electrification scheme and apparatus thereof.

According for power distribution system with DC bus electrification scheme. The method comprises: detecting what kind of disturbances occurs; and at least one of the following steps: restoring the voltages of the failed DC buses, if power loss is detected on the DC buses due to temporary or permanent failures of upstream power supplies; controlling the voltage of the abnormal DC buses, if overvoltage or under-voltage is detected on the DC buses due to internal or external disturbances; and supporting the voltages of the abnormal AC buses, if overvoltage or under-voltage is detected on the AC buses due to internal or external disturbances.

According to a preferred embodiment of the present invention, restoring the voltages of the failed DC buses further comprises: isolating the DC buses from the failed upstream power supplies by turning off corresponding circuit breakers; supporting the voltages of the isolated DC buses by controlling the ESS, the inverter-driven motor loads and/or other equipments having active power controllability connected to the isolated DC buses; controlling the voltages of the normal DC buses that are capable of supplying enough power to the isolated DC buses; and connecting the isolated DC buses to the normal DC buses with a limited inrush current.

According to another preferred embodiment of the present invention, said supporting the voltages of the isolated DC buses further comprises: calculating the voltage differences between the isolated DC buses and the normal DC buses; and one of the following calculating steps: calculating the active power references for the ESSs connected to the isolated DC buses according to their available capacities to reduce the voltage differences; calculating the speed references for the inverter-driven motor loads connected to the isolated DC buses according to their available capacities to reduce the voltage differences; calculating the active power references for other equipments having active power controllability connected to the isolated DC buses according to their available capacities to reduce the voltage differences; and sending the references to the local controllers of ESSs, inverter-driven motor loads and/or other equipments having active power controllability connected to the abnormal DC buses.

According to another preferred embodiment of the present invention, said controlling the voltages of the normal DC buses further comprises: calculating the voltage differences between the isolated DC buses and the normal DC buses; calculating the voltage references for the normal DC buses to reduce the voltage differences; and sending the voltage references to the local controllers of the power sources that supply the normal DC buses.

According to another preferred embodiment of the present invention, said connecting the isolated DC buses to the normal DC buses further comprises: calculating the voltage differences between the isolated DC buses and the normal DC buses; and turning on corresponding circuit breakers between the isolated DC buses and the normal DC buses if the voltage difference is smaller than a preset threshold.

According to another preferred embodiment of the present invention, said controlling the voltage of the abnormal DC buses further comprises: calculating the voltage differences between the reference voltages and the measured voltages of the abnormal DC buses; and one of the following calculating steps: calculating the active power references for the ESSs connected to the abnormal DC buses according to their available capacities to reduce the voltage differences; calculating the speed references for the inverter-driven motor loads connected to the abnormal DC buses according to their available capacities to reduce the voltage differences; calculating the active power references for other equipments having active power controllability connected to the abnormal DC buses according to their available capacities to reduce the voltage differences; and sending the voltage references to the local controllers of ESSs, inverter-driven motor loads and/or other equipments having active power controllability connected to the abnormal DC buses.

According to another preferred embodiment of the present invention, supporting the voltages of the abnormal AC buses further comprises: calculating voltage differences between the reference voltages and the measured voltages of the abnormal AC buses; calculating the reactive power references for the active rectifiers and/or reactive power devices connected to the abnormal AC buses to reduce the voltage differences; calculating the active power capabilities of the active rectifiers based on their rated capacity and the reactive power references; calculating the active power differences between the active power capabilities and the measured active power flows of the active rectifiers; calculating the active power references for the ESSs, inverter-driven motor loads and/or other equipments having active power controllability connected to the active rectifiers through the DC buses to compensate the active power differences for the active rectifiers if the active power differences are negative; sending reactive power references to the local controllers of the active rectifiers and/or the reactive power devices connected to the abnormal AC buses; and sending the active power references to the local controllers of the ESSs, inverter-driven motor loads and/or other equipments having active power controllability connected to the active rectifiers through the DC buses, if the active power differences are negative.

According to another aspect of the present invention, it provides a coordinated control unit for power distribution system with DC bus electrification scheme. The unit comprises: a sampling module, configured to acquire data or parameters required in the coordinated control and detects what kind of disturbance occurs; a calculation module, configured to calculate the control references for all devices under coordinated control based on said data or parameters, in order to restore the voltage of the failed DC buses, control the voltages of the abnormal DC buses, and/or support the voltages of the abnormal AC buses; an allocating module, configured to allocate said control references based on the operating conditions of the power distribution system; and an output module, configured to send said control references to the corresponding devices of the power distribution system.

According to a preferred embodiment of the present invention, said data or parameters comprise at least one of the following items: voltages, currents, circuit breaker status, rotor speeds and electromagnetic torques of inverter-driven motors.

According to another preferred embodiment of the present invention, said disturbances comprises at least one of the following types: power loss of DC buses due the either temporary or permanent failures of the upstream power supplies, overvoltage and/or under-voltage of DC buses due to faults inside or outside the power distribution system, overvoltage and/or under-voltage of AC buses due to faults inside or outside the power distribution system.

According to another preferred embodiment of the present invention, said calculation module further comprises: an ESS controller, configured to control the active power exchange between ESSs and DC buses where the ESSs connected to by adjusting the references of local controllers of ESSs; an inverter-driven motor controller, configured to control the speeds and/or torques of the motors by adjusting the local controllers of the inverters; a power source controller, configured to control the DC bus voltages by adjusting the references of the local controllers of power sources; and a breaker controller, configured to turn on/off the breakers in the power distribution system.

According to another preferred embodiment of the present invention, said calculation module further comprises at least one controller, configured to control the active power exchange between the equipments having active power controllability and the DC buses where the equipments connected to by adjusting the references of the local controllers of the equipments; and/or control the reactive power exchange between the reactive power devices and the AC buses where the devices connected to by adjusting the references of the local controllers of the devices.

According to another aspect of the present invention, it provides an apparatus for coordinated control of power distribution systems with DC electrification scheme. The apparatus comprises: at least two power sources for converting alternating current to direct current or vice versa between at least one alternating current bus and at least two direct current buses; at least two inverters, each of which is separately controlled and separately connected, on their alternating current side, to at least one associated motor, capable of storing inertial energy; a controller, configured to operate the coordinated control method according to any one of above mentioned methods; each of said at least two inverters is separately connected, on a direct current side, to said direct current bus; and said direct current bus is arranged as a multi-buses system with at least two direct current buses between which exists a direct current circuit breaker.

According to a preferred embodiment of the present invention, said apparatus further comprises an optional ESS, an optional equipment having active power controllability, and/or an optional reactive power device.

According to another preferred embodiment of the present invention, said optional equipment further comprises converter on its one side connected to at least one of said at least two direct current buses and on the other side to an alternating current sources or direct current sources; and/or said optional reactive power device further comprises at least one of the following types: active rectifier, static var compensator, capacitor banks.

According to another preferred embodiment of the present invention, said at least two power sources for converting alternating current to direct current or vice versa comprise at least active rectifiers; and said controller comprises a coordinated control unit according to any one of the above mentioned units.

According to another preferred embodiment of the present invention, said controller operates a DC bus voltage restoration control to avoid a high inrush current during automatic switching in multiples DC buses system after power losses caused by temporary or permanent failures of upstream power supplies.

According to another preferred embodiment of the present invention, said controller utilizes the active power from at least one of ESSs, equipments having active power controllability, and/or the short-term regenerative braking power from at least one motor, to do an active power control for multiple DC buses voltage stability improvement.

According to another preferred embodiment of the present invention, said controller makes a reactive power control through any of the active rectifiers and/or reactive power devices in coordination with at least one of speed control of inverter-drive motors, ESSs, and/or equipments having active power controllability under internal or external disturbances for AC buses voltage stability improvement.

Embodiments of the present invention provide coordinated control methods for power distribution system with DC bus electrification scheme and apparatus thereof, which can improve the dynamic performance of the power distribution system for fault-ride-through in terms of voltage stability improvement in both DC and AC parts as well as the current limitations and controllability in automatic switching processes between multiple DC buses etc.

### BRIEF DESCRIPTION OF THE DRAWINGS

The subject matter of the invention will be explained in more details in the following description with reference to preferred exemplary embodiments which are illustrated in the drawings, in which:

FIG. 1 illustrates a DC bus based-EBoP configuration with one generator according to the prior art;

FIG. 2 illustrates a DC bus based-EBoP configuration with two generators according to the prior art;

FIG. 3 illustrates a coordinated control method for the power distribution system with DC bus electrification scheme according to an embodiment of the present invention;

FIG. 4 illustrates a coordinated control unit for the power distribution system with DC bus electrification scheme according to an embodiment of the present invention;

FIG. 5 illustrates an apparatus for coordinated control of power distribution systems with DC electrification scheme according to an embodiment of the present invention;

FIG. 6 illustrates an apparatus for coordinated control of power distribution systems with DC electrification scheme according to another embodiment of the present invention;

FIG. 7 illustrates a flow chart of a coordinated control method for the power distribution system with DC bus electrification scheme according to an embodiment of the present invention;

FIG. 8 illustrates a flow chart of step 706 “Vdc control” in FIG. 7 according to a preferred embodiment of the present invention; and

FIG. 9 illustrates a flow chart of step 708 “Vac control” in FIG. 7 according to a preferred embodiment of the present invention.

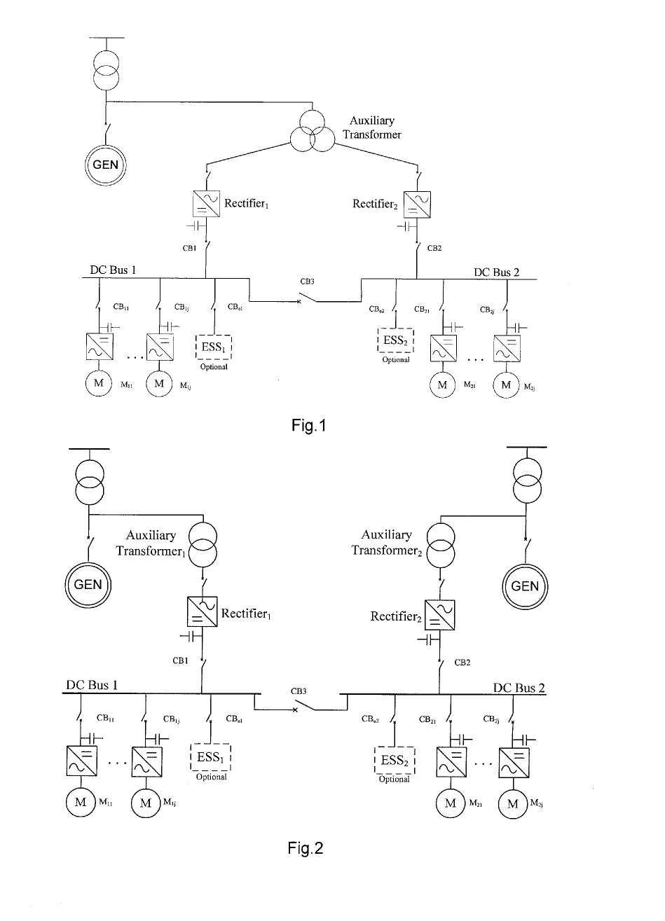

### DETAILED DESCRIPTION OF PREFERRED EMBODIMENTS

Exemplary embodiments of the present invention are described in conjunction with the accompanying drawings hereinafter. For the sake of clarity and conciseness, not all the features of actual implementations are described in the specification.

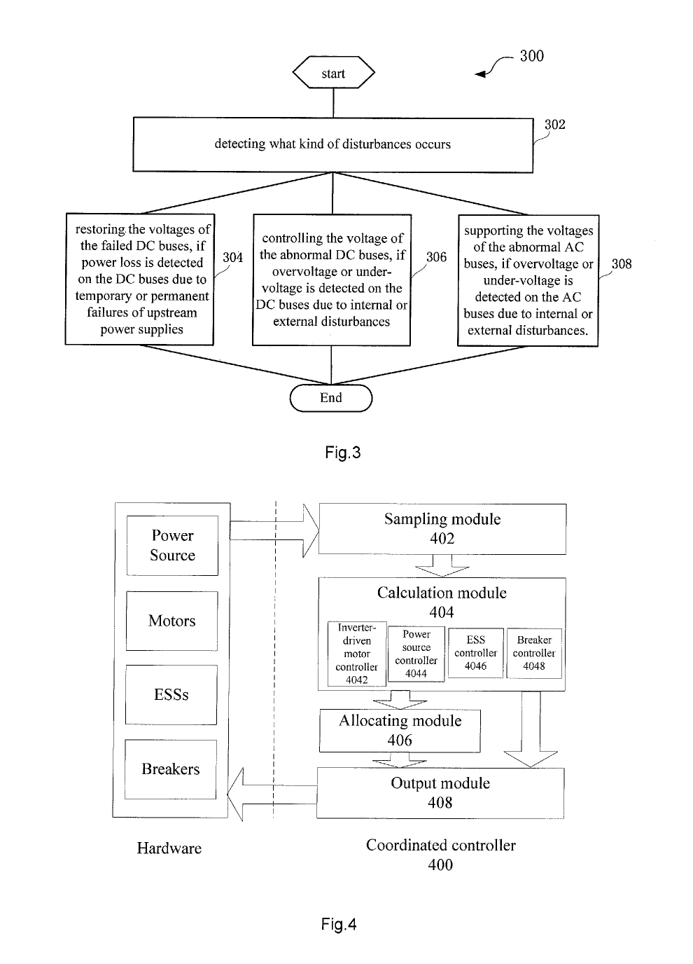

FIG. 3 illustrates a coordinated control method for the power distribution system with DC bus electrification scheme according to an embodiment of the present invention.

As shown in FIG. 3, the coordinated control method 300 mainly comprises step 302 and at least one of step 304, step 306 and step 308. It shall be noted that step 304, step 306 and step 308 will be contained in the method according to the actual implementation; moreover, such 3 steps can be implemented in parallel or in sequence.

Step 302, detecting what kind of disturbances occurs. According to the present invention, the potential disturbances comprises but not limit to at least one of the following types: power loss of DC buses due either temporary or permanent failures of the upstream power supplies, overvoltage and/or under-voltage of DC buses due to faults inside or outside the power distribution system, overvoltage and/or under-voltage of AC buses due to faults inside or outside the power distribution system.

Step 304, restoring the voltages of the failed DC buses, if power loss is detected on the DC buses due to temporary or permanent failures of upstream power supplies. For example, step 304 particularly to isolate the DC buses from the failed upstream power supplies by turning off corresponding circuit breakers; injecting active power to support the voltages of the isolated DC buses by controlling the ESS, the inverter-driven motor loads and/or other equipments having active power controllability connected to the isolated DC buses; controlling the voltages of the normal DC buses that are capable of supplying enough power to the isolated DC buses; and connecting the isolated DC buses to the normal DC buses with a limited inrush current.

Step 306, controlling the voltage of the abnormal DC buses, if overvoltage or under-voltage is detected on the DC buses due to internal or external disturbances. For example, step 306 further comprises calculating the voltage differences between the reference voltages and the measured voltages of the abnormal DC buses; calculating the active power references for the ESSs connected to the abnormal DC buses according to their available capacities to reduce the voltage differences, calculating the speed references for the inverter-driven motor loads connected to the abnormal DC buses according to their available capacities to reduce the voltage differences, and/or calculating the active power references for other equipments having active power controllability connected to the abnormal DC buses according to their available capacities to reduce the voltage differences; sending the corresponding references to the local controllers of ESSs, inverter-driven motor loads and/or other equipments having active power controllability connected to the abnormal DC buses.

Step 308, supporting the voltages of the abnormal AC buses, if overvoltage or under-voltage is detected on the AC buses due to internal or external disturbances. For example, step 308 further comprises calculating voltage differences between the reference voltages and the measured voltages of the abnormal AC buses; calculating the reactive power references for the active rectifiers and/or reactive power devices connected to the abnormal AC buses to reduce the voltage differences; sending the reactive power references and/or active power references to the local controllers of active rectifier, reactive power devices, and/or ESSs, inverter-driven motor loads and/or other equipments having active power controllability connected to the active rectifiers through the DC buses.

In detail, in an optimal embodiment of the present invention, the step “supporting the voltages of the isolated DC buses” further comprises: calculating the voltage differences between the isolated DC buses and the normal DC buses; calculating the active power references for the ESSs connected to the isolated DC buses according to their available capacities to reduce the voltage differences; calculating the speed references for the inverter-driven motor loads connected to the isolated DC buses according to their available capacities to reduce the voltage differences; calculating the active power references for other equipments having active power controllability connected to the isolated DC buses according to their available capacities to reduce the voltage differences; and sending the references to the local controllers of ESSs, inverter-driven motor loads and/or other equipments having active power controllability connected to the abnormal DC buses. The step “controlling the voltages of the normal DC buses” further comprises calculating the voltage differences between the isolated DC buses and the normal DC buses; calculating the voltage references for the normal DC buses to reduce the voltage differences; sending the voltage references to the local controllers of the power sources that supply the normal DC buses. The step “connecting the isolated DC buses to the normal DC buses” further comprises calculating the voltage differences between the isolated DC buses and the normal DC buses; turning on corresponding circuit breakers between the isolated DC buses and the normal DC buses if the voltage difference is smaller than a preset threshold. More details will be illustrated by referring to the following figures.

With above coordinated control methods, active power balancing of DC bus system can be achieved under external disturbances by utilizing the regenerative power from short-term motor braking, and/or power from ESSs or other equipments having active power controllability, so that the required DC bus voltage level can be maintained. Meanwhile the input AC voltage of the rectifiers can also be maintained within the allowed range by controlling the reactive power output of the active rectifiers and/or other reactive power devices.

It shall be noted that the person skilled in art can preset the thresholds based on the actual implementation, and such preset thresholds are used as judgment standards to identify “abnormal” conditions.

FIG. 4 illustrates a coordinated control unit for the power distribution system with DC bus electrification scheme according to an embodiment of the present invention.

As shown in FIG. 4, the coordinated control unit 400 comprises a sampling module 402, a calculation module 404, an allocating module 406 and a configuration module 408; in which the sampling module 402 is configured to acquire data or parameters required in the coordinated control and detects what kind of disturbance occurs; and said data or parameters comprise at least one of the following items: voltages, currents, circuit breaker status, rotor speeds and electromagnetic torques or inverter-driven motors. The calculation module 404 is configured to calculate the control references for all devices under coordinated control based on said data or parameters, in order to restore the voltage of the failed DC buses, control the voltages of the abnormal DC buses, and/or support the voltages of the abnormal AC buses; the allocating module 406 is configured to allocate said control references based on the operating conditions of the power distribution system; and the output module 408 is configured to send said control references to the corresponding devices of the power distribution system.

According to a preferred embodiment of the present invention, said calculation module 404 further comprises an inverter-driven motor controller 4042, a power source controller 4044, an ESS controller 4046 and a breaker controller 4048; in which the inverter-driven motor controller 4042 is configured to control the speeds and/or torques of the motors; the power source controller 4044 is configured to control the DC bus voltages and the reactive power output of the active rectifiers; the ESS controller 4046 is configured to control the active power exchange between ESSs and DC buses where the ESSs connected to; and the breaker controller 4048 is configured to turn on/off the breakers in the power distribution system.

Furthermore, in an actual implementation, the calculation module 404 further comprises at least one controller which is configured to control the active power exchange between the equipments having active power controllability and the DC buses where the equipments connected to by adjusting the references of the local controllers of the equipments; and/or control the reactive power exchange between the reactive power devices and the AC buses where the devices connected to by adjusting the references of the local controllers of the devices.

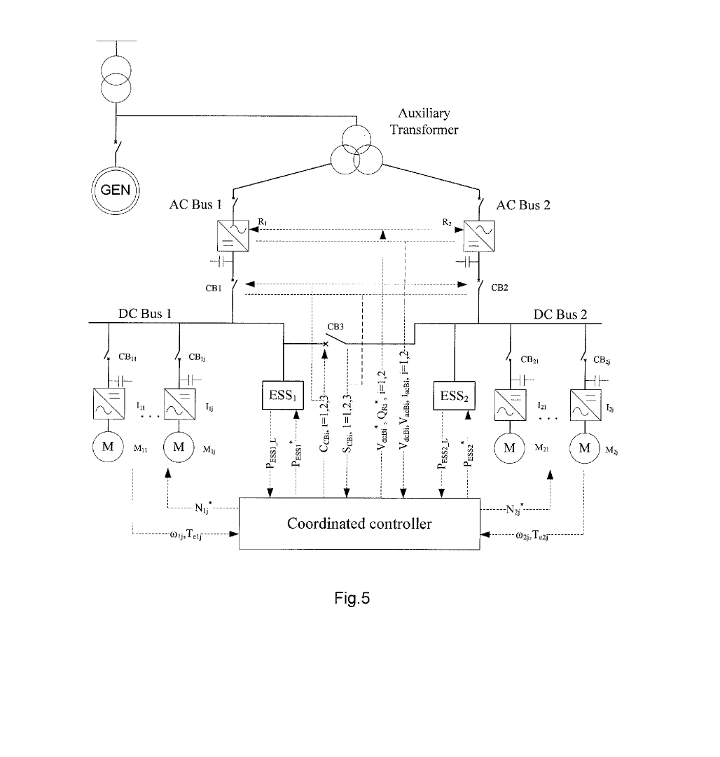

FIG. 5 illustrates an apparatus for coordinated control of power distribution systems with DC electrification scheme according to an embodiment of the present invention.

As shown in FIG. 5, the apparatus for coordinated control comprises at least two power sources (for example, at least comprising active rectifiers R₁, R₂ and the like), at least two DC buses (DC Bus 1, DC Bus 2), at least two inverters (I₁₁, . . . I₁ⱼ; I₂₁, . . . I₂ⱼ) and associated motors (M₁₁, . . . M₁ⱼ; M₂₁, . . . M₂ⱼ) respectively, a coordinated controller; in which said at least two power sources (R₁, R₂) are configured to convert AC to DC or vice versa between at least one AC bus and at least two DC buses (DC Bus 1, DC Bus 2); each of said at least two inverters (I₁₁, . . . I₁ⱼ; I₂₁, . . . I₂ⱼ) is separately controlled and separately connected, on the AC side, to said at least one associated motor (M₁₁, . . . M₁ⱼ; M₂₁, . . . M₂ⱼ), capable of storing inertial energy; said controller is configured to operate the coordinated control method according to above mentioned methods; each of said at least two inverters is separately connected, on a DC side, to said DC bus; and said DC bus is arranged as a multi-buses system with at least two DC buses between where exists a DC circuit breaker.

It should be noted that the coordinated controller in FIG. 5 is taken for an example for DC voltage restoration, DC voltage control, and AC voltage support in such a power plant with two DC buses. The controlled system runs data acquisition, such as voltages, currents, breaker status, rotor speeds and electromagnetic torques from auxiliary transformers, rectifiers (R₁, R₂), DC buses (DC Bus 1 and DC Bus 2), breakers (CB1, CB2 and CB3), motors (M₁₁, . . . M₁ⱼ; M₂₁, . . . M₂ⱼ), etc. Based on the built-in control logics and/or algorithms of the controller, the switching commands (ON/OFF) of beakers, the DC voltage reference and the reactive power reference of rectifiers, and the speed reference for inverter-motor branches will be calculated. The determined or calculated commands and references will sent to corresponding devices.

According to a preferred embodiment of the present invention, the apparatus further comprises an optional ESS (ESS₁, ESS₂), an optional equipment having active power controllability, and/or an optional reactive power device; in which the optional equipment further comprises converter on its one side connected to at least one of said at least two DC buses and on the other side to an AC sources or DC sources; and the optional reactive power device further comprises at least one of the following types: active rectifier, SVC (static var compensator), capacitor banks etc.

The variables for measurement and/or control include but not limit to the followings:

DC Bus voltage (V_{dcB1}, V_{dcB2}), AC Bus Voltage (V_{acB1}, V_{acB2}) and current (I_{acB1}, I_{acB2}); which can be used to calculated the active power (P_{R1}, P_{R2}) and reactive power of rectifiers (Q_{R1}, Q_{R2});

Reactive power reference of rectifiers R1 and R2: Q_{R1}*, Q_{R2}*;

Bus voltage reference of rectifiers R1 and R2: V_{dcB1}*, V_{dcB2}*;

On/off status of breakers: S_{CB1}, S_{CB2}, S_{CB3};

On/off commands of breakers: C_{CB1}, C_{CB2}, C_{CB3};

Rotor speeds (ωᵢⱼ) and electromagnetic torques (Tₑᵢⱼ); which can be used to calculated the power consumption of inverter-driven motors (M₁₁, . . . M₁ⱼ; M₂₁, . . . M₂ⱼ);

Speed reference (Nᵢⱼ*) of inverters (I₁₁, . . . I₁ⱼ; I₂₁, . . . I₂ⱼ);

Active power reference of ESS: P_{ESS1}*, P_{ESS2}*;

Available power capacity of ESS: P_{ESS1}_{_{—}}_{L}, P_{ESS2}_{_{—}}_{L}.

The present invention describes a coordinated control concept for operating the controllable devices connected to the DC buses, including rectifiers, inverters/motors, ESSs, circuit breakers to improve the power plant fault-ride-through capability under external or internal disturbances. Commuting two DC buses, an automatic switching scheme between mutually backup DC buses, is another important feature of the proposed control system under internal disturbances, e.g. power loss caused by component failure, to avoid high inrush current during the switching between two DC buses.

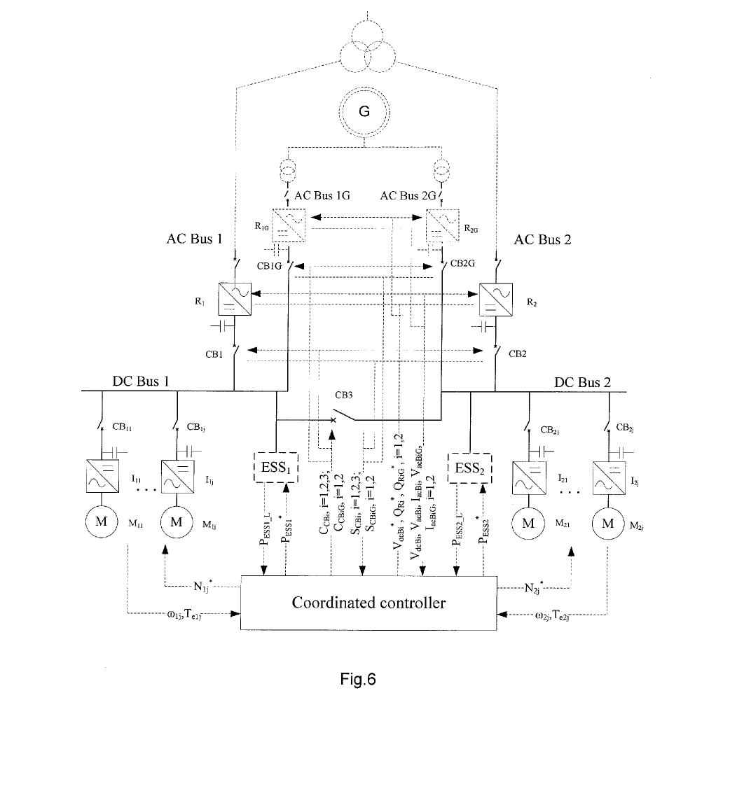

FIG. 6 illustrates an apparatus for coordinated control of power distribution system with DC electrification scheme according to another embodiment of the present invention.

As shown in FIG. 6, the main difference lies in that power sources include other rectifiers (R_{1G}, R_{2G}) besides two rectifiers (R₁, R₂) in FIG. 5, an associated generator (G) on its AC side connected to at least one of said at least two AC buses (AC Bus 1G, AC Bus 2G); that's to say, the power sources connected to at least two DC buses (DC Bus 1, DC Bus 2) include but not limit to grid connected rectifiers (R₁, R₂) and associated generator connected rectifiers (R_{1G}, R_{2G}), for converting AC to DC or vice versa between AC buses (AC Bus 1, AC Bus 2, AC Bus 1G, AC Bus 2G) and at least two DC buses (DC Bus 1, DC Bus 2); in which said power sources (R₁, R₂, R_{1G}, R_{2G}) are arranged to provide power to said DC bus (DC Bus 1, DC Bus 2). Other elements are the same or similar to the corresponding elements in FIG. 5. In order to keep the description brief, the same or similar elements will not be described again.

Based on the apparatus shown in FIG. 5 or FIG. 6 as well as other similar variations without departing from the spirit and concept of the present invention, the coordinated controller implements a DC bus voltage restoration control to avoid a high inrush current during automatic switching in multiples DC buses system after power losses caused by temporary or permanent failures of upstream power supplies, utilizes the active power from at least one of ESSs, equipments having active power controllability, and/or the short-term regenerative braking power from at least one motor, to do an active power control for multiple DC buses voltage stability improvement; and makes a reactive power control through any of the active rectifiers and/or reactive power devices in coordination with at least one of speed control of inverter-drive motors, ESSs, and/or equipments having active power controllability under internal or external disturbances for AC buses voltage stability improvement.

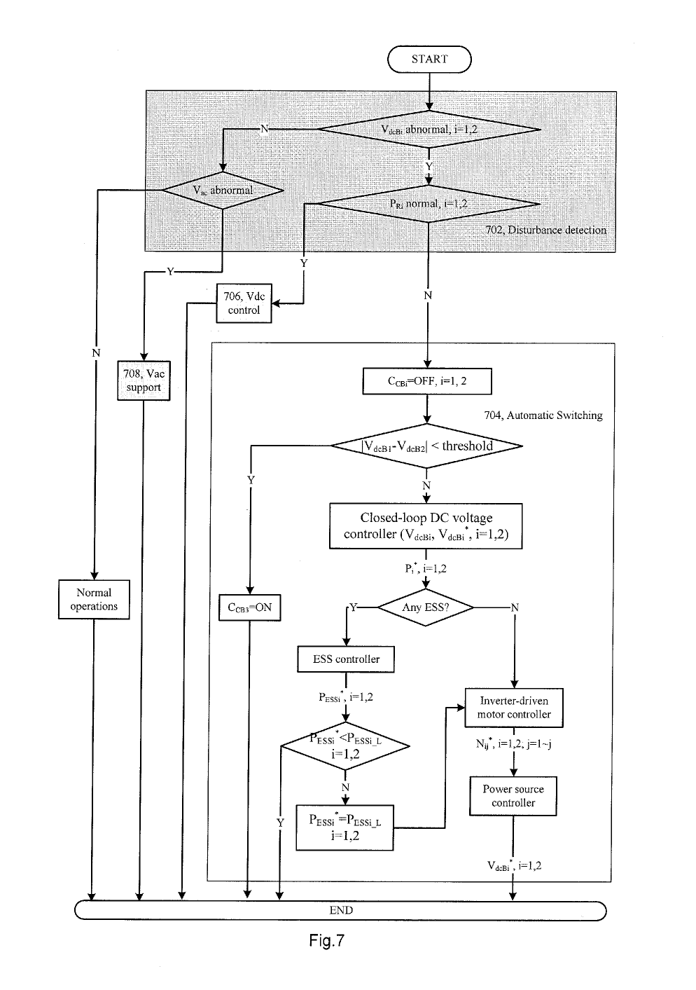

FIG. 7 illustrates a flow chart of a coordinated control method for the power distribution system with DC bus electrification scheme according to an embodiment as shown in FIG. 5 of the present invention.

As shown in FIG. 7, the coordinated control method comprises the following main steps:

Step 702, disturbance detection for detecting what kind of disturbance occurs. For example, if DC bus voltage is above a preset upper threshold or below a preset lower threshold, and meanwhile active power provided by the power source is normal, which means DC voltage abnormal, then goes to step 706; if AC bus voltage is above a preset upper threshold or below a preset lower threshold, which means AC voltage abnormal, then goes to step 708; if DC bus voltage is below a preset lower threshold and meanwhile the active power provided by the power source is nearly zero, which means power loss, then goes to step 704.

Step 704, automatic switching between two DC buses to transfer the load connected to the failed DC Bus to the normal DC Bus smoothly, if the voltage of DC Bus is lower than normal and the active power of the rectifier is near to zero. For example, if the rectifier R1 connected DC Bus 1 fails, it is desirable to transfer the load of the failed DC Bus 1 which loses the power supply to the normal DC Bus 2 with enough power supply capability as quickly as possible in order to maintain normal power plant operation. The main procedures include calculating the voltage difference between DC Bus 1 and DC Bus 2 after opening the circuit breaker CB 1; if the voltage difference is higher than a preset threshold, taking actions to reduce the voltage difference by controlling the ESSs and/or inverter-driven motors connected to DC Bus 1, and the active rectifier connected to DC Bus 2; otherwise directly turning on the circuit breaker CB3 between the two DC Buses.

It should be noticed that such actions include injecting active power from ESSs, reducing motor load by adjusting the references for the inverters, and setting new DC Bus 2 voltage reference of the rectifier R2. If there exists ESSs connected to DC Bus 1, the active power reference P_{ESS1}* will be calculated by ESS controller 4046; and if there is no ESS connected to DC Bus 1 or the active power reference P_{ESS1}* is higher than the available capacity P_{ESS1}_{_{—}}_{L}, inverter-driven motor controller 4042 will be enabled to calculate the speed reference N₁ⱼ* to operate the inverter-driven motors connected to DC Bus 1. Power source controller 4044 will then calculate DC Bus 2 voltage reference of rectifier R2 in order to reduce the voltage difference.

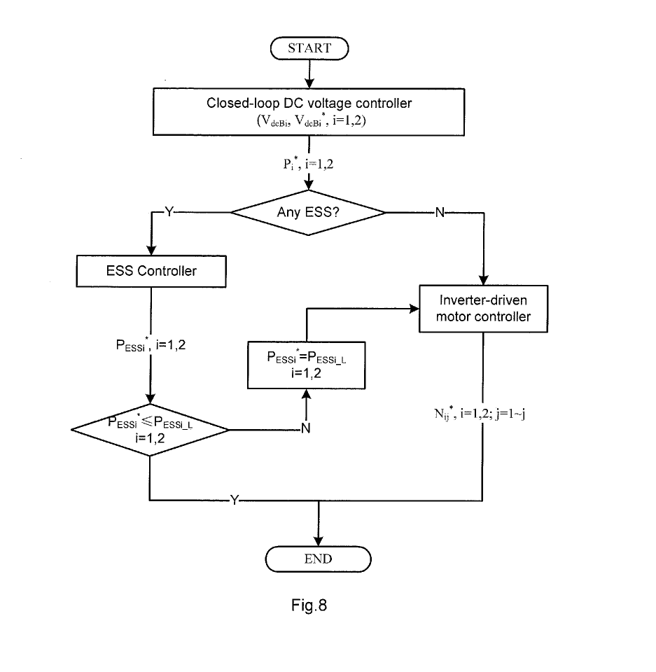

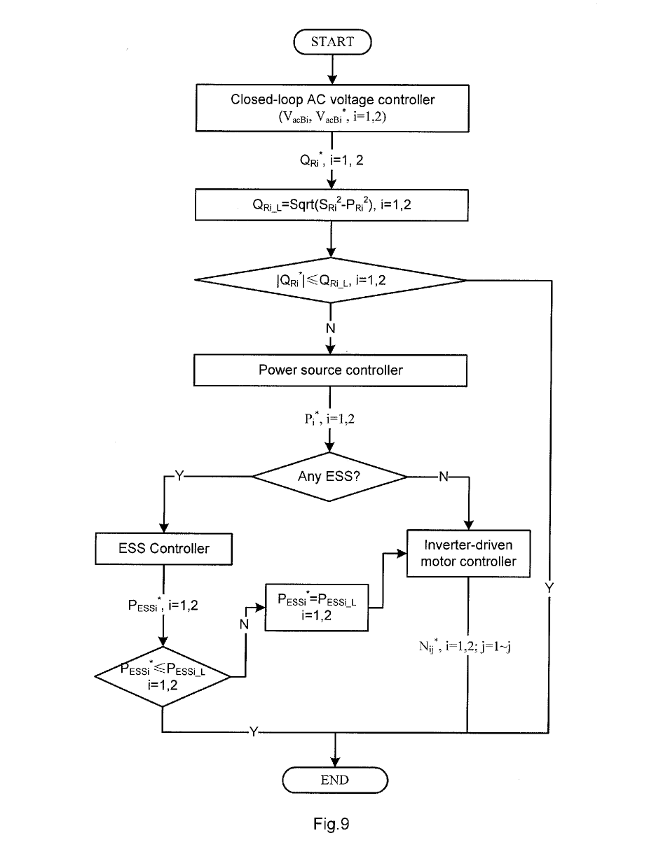

Step 706, V_{dc} control for controlling the voltage of the abnormal DC Bus. The detailed process of Step 706 will be further illustrated in FIG. 8 and described later.

Step 708, V_{ac} support for supporting the voltage of the abnormal AC bus. The detailed process of Step 708 will be further illustrated in FIG. 9 and described later.

Above mentioned methods of the present invention are used to achieve coordinated control of the active and reactive power flow for DC voltage control and AC system voltage support under internal or external disturbances, furthermore implement the coordinated control of motor speeds in the ASDs in automatic switching processes between two DC buses for current limitations and controllability.

FIG. 8 illustrates a flow chart of step 706 “V_{dc} control” in FIG. 7 according to a preferred embodiment of the present invention.

As shown in FIG. 8, the process “V_{dc} control” further comprises: calculating the total active power demand through closed-loop DC voltage controller in order to maintain the DC Bus voltage of the rectifier at the reference value, and determining the control references for ESSs and/or inverter-driven motors to contribute for the total active power demand. For example, if DC Bus 1 voltage is abnormal, the closed-loop controller will calculate the active power demand P₁* in order to reduce the error between the reference V_{dcB1}* and the actual value V_{dcB1}. If there exists any ESS connected to DC Bus 1, the required active power P_{ESS1}* will be calculated by ESS controller 4046 and compared with the available active power capacity of ESS P_{ESS1}_{_{—}}_{L}; otherwise, if there is no ESS, or P_{ESS1}* is higher than P_{ESS1}_{_{—}}_{L}, the inverter-driven motor controller 4042 will be enabled to calculate the speed references Nᵢⱼ^{*} to operate the inverter-driven motors connected to DC Bus 1.

FIG. 9 illustrates a flow chart of step 708 “V_{ac} support” in FIG. 7 according to a preferred embodiment of the present invention.

As shown in FIG. 9, AC voltage support process is to control the reactive power output of rectifiers to reduce the variation of the AC voltage, which comprises calculating the desired reactive power through closed-loop AC voltage controller in order to maintain the AC Bus voltage of the rectifier at the rated value; calculating the available reactive power capacity of the rectifiers; and if the desired reactive power is higher than the available capacity of the rectifier, ESS controller and/or inverter-driven motor controller will be enabled to reduce the active power flow of the rectifier, so as to temporarily release the capacity for reactive power output. For example, if AB Bus 1 voltage is abnormal, the closed-loop controller will calculate the reactive power demand Q_{R1}* in order to reduce the error between the rated voltage V_{acB1}* and the actual value V_{acB1}. Then the available reactive power capacity Q_{R1}_{_{—}}_{L} will be calculated and compared with Q_{R1}*. If Q_{R1}* is higher than Q_{R1}_{_{—}}_{L}, the power source controller will be enabled to calculate the required active power flow P₁* that should be released by ESSs and/or inverter-driven motors. The following procedures are similar to Step 706 and will not be described again to keep the description brief.

According to the above description, such methods of coordinated control and apparatus thereof can be applied to improve the fault-ride-through capability of DC bus based electrification scheme in power distribution system such as the automated industrial facilities, and the electrical power generation plants.

Compared with the existing prior arts, the proposed solution of the present invention is much more practical and easier for implementation on the MTDC (multi-terminal direct current) system. Referring to the description of the exemplary embodiments, those skilled in the art appreciate the advantages of the present invention:

1. According to the coordinated control methods for power distribution system with DC bus electrification scheme and apparatus thereof provided in the present invention, the methods and apparatus can control the loads connected to the DC bus to balance the power so as to control the DC bus voltage.

2. According to the coordinated control methods for power distribution system with DC bus electrification scheme and apparatus thereof provided in the present invention, the methods and apparatus can control the loads connected to the DC bus to release the capacity of the rectifier temporarily to support the AC side voltage by controlling the reactive power output of the rectifiers.

3. According to the coordinated control methods for power distribution system with DC bus electrification scheme and apparatus thereof provided in the present invention, the methods and apparatus can control the rectifiers and the loads connected to the DC bus to reduce the voltage difference between the two buses so as to facilitate the automatic switching process.

4. According to the coordinated control methods for power distribution system with DC bus electrification scheme and apparatus thereof provided in the present invention, the methods and apparatus can further improve the fault-ride-through capability for power plant under external or internal disturbances.

Though the present invention has been described on the basis of some preferred embodiments, those skilled in the art should appreciate that those embodiments should by no means limit the scope of the present invention. Without departing from the spirit and concept of the present invention, any variations and modifications to the embodiments should be within the apprehension of those with ordinary knowledge and skills in the art, and therefore fall in the scope of the present invention which is defined by the accompanied claims.

1. A coordinated control method for a power distribution system with DC bus electrification scheme, comprising:
detecting what kind of disturbances occurs; wherein said method further comprises at least one of the following steps:
restoring voltages of failed DC buses, if power loss is detected on the failed DC buses due to temporary or permanent failures of upstream power supplies;
controlling a voltage of abnormal DC buses, if overvoltage or under-voltage is detected on the abnormal DC buses due to internal or external disturbances; and
supporting voltages of abnormal AC buses, if overvoltage or under-voltage is detected on the abnormal AC buses due to internal or external disturbances.

2. The coordinated control method according to claim 1, wherein said restoring the voltages of the failed DC buses further comprises:
isolating the failed DC buses from the failed upstream power supplies by turning off corresponding circuit breakers;
supporting the voltages of the isolated failed DC buses by controlling ESSs, inverter-driven motor loads and/or other equipment having active power controllability connected to the isolated failed DC buses;
controlling voltages of normal DC buses that are capable of supplying enough power to the isolated failed DC buses; and
connecting the isolated failed DC buses to the normal DC buses with a limited inrush current.

3. The coordinated control method according to claim 2, wherein said supporting the voltages of the isolated failed DC buses further comprises:
calculating voltage differences between the isolated failed DC buses and the normal DC buses;
one of the following calculating steps:
calculating active power references for the ESSs connected to the isolated failed DC buses according to their available capacities to reduce the voltage differences;
calculating speed references for the inverter-driven motor loads connected to the isolated failed DC buses according to available capacities of the inverter-driven motor loads to reduce the voltage differences; and
calculating the active power references for other equipment having active power controllability connected to the isolated failed DC buses according to available capacities of the other equipment to reduce the voltage differences; and
sending the active power references to local controllers of ESSs, the inverter-driven motor loads and/or the other equipment having active power controllability connected to the abnormal DC buses.

4. The coordinated control method according to claim 2, wherein said controlling the voltages of the normal DC buses further comprises:
calculating voltage differences between the isolated failed DC buses and the normal DC buses;
calculating voltage references for the normal DC buses to reduce the voltage differences; and
sending the voltage references to local controllers of power sources that supply the normal DC buses.

5. The coordinated control method according to claim 2, wherein said connecting the isolated failed DC buses to the normal DC buses further comprises:
calculating voltage differences between the isolated failed DC buses and the normal DC buses; and
turning on corresponding circuit breakers between the isolated failed DC buses and the normal DC buses if the voltage difference is less than a preset threshold.

6. The coordinated control method according to claim 1, wherein said controlling the voltage of the abnormal DC buses further comprises:
calculating voltage differences between reference voltages and measured voltages of the abnormal DC buses;
one of the following calculating steps:
calculating active power references for ESSs connected to the abnormal DC buses according to available capacities of the ESSs to reduce the voltage differences;
calculating speed references for inverter-driven motor loads connected to the abnormal DC buses according to available capacities of the inverter-driven motor loads to reduce the voltage differences; and
calculating active power references for other equipments having active power controllability connected to the abnormal DC buses according to available capacities of the other equipment to reduce the voltage differences; and
sending the voltage references to local controllers of the ESSs, the inverter-driven motor loads and/or the other equipments having active power controllability connected to the abnormal DC buses.

7. The coordinated control method according to claim 1, wherein supporting the voltages of the abnormal AC buses further comprises:
calculating voltage differences between reference voltages and measured voltages of the abnormal AC buses;
calculating reactive power references for active rectifiers and/or reactive power devices connected to the abnormal AC buses to reduce the voltage differences;
calculating active power capabilities of the active rectifiers based on their rated capacity of the active rectifiers and the reactive power references;
calculating active power differences between the active power capabilities and measured active power flows of the active rectifiers;
calculating active power references for ESSs, inverter-driven motor loads and/or other equipment having active power controllability connected to the active rectifiers through the DC buses to compensate the active power differences for the active rectifiers if the active power differences are negative;
sending reactive power references to local controllers of the active rectifiers and/or the reactive power devices connected to the abnormal AC buses; and
sending the active power references of the ESSs to the local controllers of the ESSs, inverter-driven motor loads and/or other equipments having active power controllability connected to the active rectifiers through the DC buses, if the active power differences are negative.

8. A coordinated control unit for a power distribution system with DC bus electrification scheme, wherein said unit comprises:
a sampling module that acquires data or parameters required in the coordinated control and detects a kind of disturbance;
a calculation module that calculates control references for all devices under coordinated control based on said data or said parameters, to restore a voltage of failed DC buses, control voltages of abnormal DC buses, and/or support voltages of abnormal AC buses;
an allocating module that allocates said control references based on operating conditions of said power distribution system; and
an output module that sends said control references to corresponding devices of said power distribution system.

9. The coordinated control unit according to claim 8, wherein said data or said parameters comprise at least one of voltages, currents, circuit breaker status, rotor speeds and electromagnetic torques.

10. The coordinated control unit according to claim 8, wherein said disturbances comprises at least one of power loss of DC buses due to either temporary or permanent failures of upstream power supplies, overvoltage and/or under-voltage of the DC buses due to faults inside or outside said power distribution system, overvoltage and/or under-voltage of AC buses due to faults inside or outside said power distribution system.

11. The coordinated control unit according to claim 8, wherein said calculation module further comprises:
an ESS controller that controls an active power exchange between ESSs and DC buses where the ESSs connected to by adjusting references of local controllers of the ESSs;
an inverter-driven motor controller that controls speeds and/or torques of motors by adjusting local controllers of the inverters;
a power source controller that controls the DC bus voltages by adjusting references of local controllers of power sources; and
a breaker controller that turns on/off breakers in the power distribution system.

12. The coordinated control unit according to claim 11, wherein said calculation module further comprises at least one controller that:
controls an active power exchange between equipment having active power controllability and the DC buses where the equipment connected to by adjusting the references of the local controllers of the equipment; and/or
controls reactive power exchange between reactive power devices and AC buses where the devices connected to by adjusting the references of the local controllers of the devices.

13. An apparatus for coordinated control of power distribution systems with DC electrification scheme, wherein said apparatus comprises:
at least two power sources for converting alternating current to direct current or vice versa between at least one alternating current bus and at least two direct current buses;
at least two inverters, each of the at least two inverters is separately controlled and separately connected, on their alternating current side, to at least one associated motor, capable of storing inertial energy;
a controller that operates the coordinated control method according to claim 1;
each of said at least two inverters is separately connected, on a direct current side, to said direct current bus; and
said direct current bus is arranged as a multi-buses system with a, wherein a direct current circuit breaker is between the at least two direct current buses.

14. The apparatus according to claim 13, wherein said apparatus further comprises an optional ESS, an optional equipment having active power controllability, and/or an optional reactive power device.

15. The apparatus according to claim 14, wherein,
said optional equipment further comprises a converter on one side of the optional equipment connected to at least one of said at least two direct current buses and on an other side of the optional equipment to an alternating current source or a direct current source; and/or
said optional reactive power device further comprises at least one of active rectifier, static var compensator, and capacitor banks.

16. The apparatus according to claim 13, wherein,
said at least two power sources for converting alternating current to direct current or vice versa comprise at least active rectifiers; and
said controller comprises a coordinated control unit according to claim 8.

17. The apparatus according to claim 13, wherein said controller operates a DC bus voltage restoration control to avoid a high inrush current during automatic switching in a multiples DC bus system after power losses caused by temporary or permanent failures of upstream power supplies.

18. The apparatus according to claim 13, wherein said controller utilizes active power from at least one of ESSs, equipments having active power controllability, and/or short-term regenerative braking power from at least one motor, to perform an active power control for multiple DC buses voltage stability improvement.

19. The apparatus according to claim 13, wherein said controller makes a reactive power control through active rectifiers and/or reactive power devices in coordination with at least one of speed control of inverter-drive motors, ESSs, and/or equipment having active power controllability under internal or external disturbances for AC buses voltage stability improvement.

20. The apparatus according to claim 13, wherein, said at least two power sources for converting alternating current to direct current or vice versa comprise at least active rectifiers; and said controller comprises a coordinated control unit according to claim 9.
